(19) United States
(12) Patent Application Publication
(10) Pub. No.: US 2007/0077049 A1
(43) Pub. Date: Apr. 5, 2007

(54) DIGITAL CAMERA MODULE

(75) Inventor: MING-CHIANG TSAI, Tu-Cheng,Taipei Hsien (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Taipei Hsien (TW)

(21) Appl. No.: 11/309,302

(22) Filed: Jul. 24, 2006

(30) Foreign Application Priority Data
Sep. 30, 2005 (CN) 200510100057.X

(51) Int. Cl. G03B 3/00

(52) U.S. Cl. 396/91

(57) ABSTRACT

An exemplary digital camera module (10) includes a lens module (20), an image sensor (2202) and a rotating structure (30). The lens module includes a barrel and at least one lens (211) received in the barrel. The at least one lens defines an optical axis (214). The image sensor (2202) is arranged to receive light transmitted through the at least one lens. The rotating structure is attached to the lens module. The rotating structure includes a driving member (32) configured for driving the lens module to rotate about a rotating axis (312) oblique to the optical axis while the lens module is imaging.

### FIELD OF THE INVENTION

The present invention generally relates to digital camera modules, and more particularly to a digital camera module for a portable electronic device.

### DESCRIPTION OF RELATED ART

Nowadays, digital camera modules are in widespread use in a variety of portable electronic devices. For example, digital camera modules are now widely available as a special feature for mobile phones, and since the mobile phones have become smaller and smaller, the digital camera modules used in the mobile phones are also becoming correspondingly smaller and smaller. Nevertheless, besides the small size of a contemporary digital camera module, consumers also demand a wider photographing field for excellent imaging which requires a wide-angle view.

However, the view angle of a digital camera lens generally is only sixty degrees, so that the angular range is limited unless a wide-angle lens is used. However, since the digital camera module for a mobile phone is required to be small sized to meet the small volume of the mobile phone, but wide-angle lens modules have relatively large size, so the common wide-angle lens module can't be used for a mobile phone.

Accordingly, what is needed is a digital camera module for a portable electronic device which supports wide-angle photographing and is small sized.

### SUMMARY OF THE INVENTION

In one embodiment thereof, a digital camera module includes a lens module, an image sensor and a rotating structure. The lens module includes a barrel and at least one lens received in the barrel. The at least one lens defines an optical axis. The image sensor is arranged to receive light transmitted through the at least one lens. The rotating structure is attached to the lens module. The rotating structure includes a driving member configured for driving the lens module to rotate about a rotating axis oblique to the optical axis while the lens module is imaging.

Other advantages and novel features will become more apparent from the following detailed description when taken in conjunction with the accompanying drawings.

### BRIEF DESCRIPTION OF THE DRAWINGS

Many aspects of the digital camera module can be better understood with reference to the following drawings. The components in the drawings are not necessarily drawn to scale, the emphasis instead being placed upon clearly illustrating the principles of the present digital camera module. Moreover, in the drawings, like reference numerals designate corresponding parts throughout the several views.

FIG. 1 is an isometric view of a digital camera module in accordance with an embodiment of the present invention; and

FIG. 2 is a partly cross-sectional view of the digital camera module taken along line 11-11 of FIG. 1.

### DETAILED DESCRIPTION OF THE INVENTION

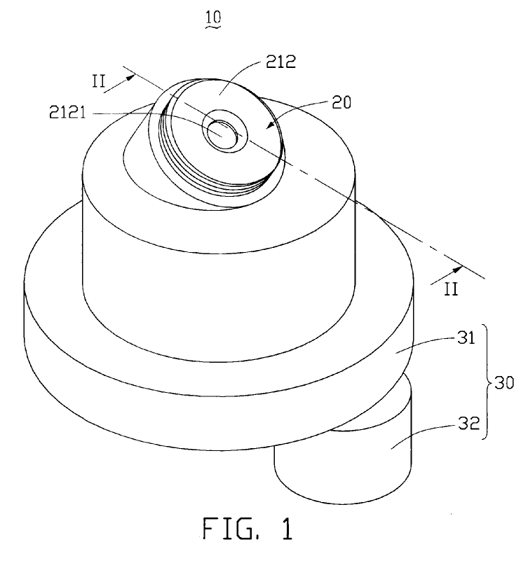

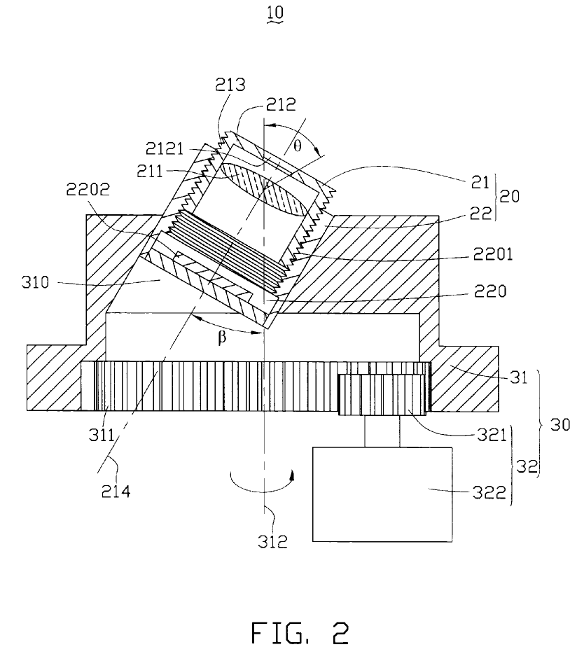

Referring to FIG. 1 and FIG. 2, an embodiment of a digital camera module 10 used in such a portable electronic device as a mobile phone includes a lens module 20 and a rotating structure 30.

The lens module 20 includes an inner barrel 21 and an outer barrel 22. The inner barrel 21 is a hollow cylinder in shape, and at least one lens 211 is received in it. The at least one lens 211 defines an optical axis 214. The at least one lens 211 and the inner barrel 21 are coaxial. A closing board 212 is provided at a front end of the inner barrel 21. An aperture 2121 is formed on the closing board 212 along the optical axis 214. The view angle of the aperture 2121 is designated by θ which is between 30 and 90 degrees. θ is a 60-degree angle in this exemplary embodiment. An outer screw thread 213 is formed on an outer periphery of the inner barrel 21.

The outer barrel 22 is a hollow cylinder, and is coaxial with the inner barrel 21 and the at least one lens 211. A lens hole 220 is defined in the outer barrel 22 and along the optical axis 214 thus allowing light to be transmitted therethrough. An inner screw thread 2201 is formed on an inner periphery of the outer barrel 22. The inner screw thread 2201 engages with the outer screw thread 213 of the inner barrel 21, thereby axially movably mounting the inner barrel 21 in the outer barrel 22. An image sensor 2202 is received in the lens hole 220 of the outer barrel 22 and configured for receiving light transmitted through the lens 211.

The rotating structure 30 includes a lens holder 31 and a driving member 32. The lens holder 31 is a substantially hollow cylinder, and it defines a rotating axis 312. A receiving hole 310 is defined in one end of the lens holder 31. The receiving hole 310 is configured for receiving the lens module 20 therein. Transmission teeth 311 are formed on the inner periphery of the other end of the lens holder 31. The driving member 32 includes a rod 321 and a driving motor 322 connected with the rod 321. The rod 321 is for interacting with the transmission teeth 311. When the lens module 20 is mounted in the receiving hole 310, the optical axis 214 has an oblique angle according to the rotating axis 312 of the lens holder 31. The oblique angle is designated by β which is a 30-degree angle in the embodiment.

In assembly, the at least one lens 211 is mounted in the inner barrel 21. The image sensor 2202 is received in the outer barrel 22. The inner barrel 21 with the lens 211 is mounted in the outer barrel 22 by the engagement of the outer screw thread 213 with the inner screw thread 2201, and the image sensor 2202 is located on the image plane of the lens module 20. After assembly, the lens module 20 is mounted in the receiving hole 310. The rod 321 of the driving member 32 fits with the transmission teeth 311 of the lens holder 31. The driving motor 322 is connected with the rod 321 for driving the rod 321 to rotate.

In use, the image sensor 2202 is connected with an image processor provided in the mobile phone. The driving motor 322 drives the lens holder 31 together with the lens module 20 to rotate relative to the axis of the lens holder 31 to any angle. The driving motor 322 rotates the lens holder 31 and the lens module 20 through a 360 degree angle whilst the lens module 20 captures images. The image processor connected with the image sensor 2202 synthesizes the captured images to create a wide-angle image. In the embodiment, the aperture 2121 of the lens module 20 has a 60-degree angle of view, and the oblique angle between the optical axis 214 and the rotating axis 312 is 30 degrees, thus giving the synthesized image a 120-degree angle of view. The digital camera module 10 may thus perform wide-angle shooting without alteration of the lens module 20.

In an alternative embodiment, the lens holder 31, the outer barrel 22 and the inner barrel 21 can be in a single module. In addition to a mobile phone, the digital camera module 10 can also be used for portable electronic devices such as personal digital assistant (PDA), and the like.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A digital camera module comprising:
a lens module including a barrel and at least one lens received in the barrel, the at least one lens defining an optical axis;
an image sensor arranged to receive light transmitted through the at least one lens; and
a rotating structure attached to the lens module, the rotating structure comprising a driving member configured for driving the lens module to rotate about a rotating axis oblique to the optical axis while the lens module is imaging.

2. The digital camera module as claimed in claim 1, wherein the barrel has an outer barrel and an inner barrel received in the outer barrel, the lens is received in the inner barrel, and a lens hole is defined in the outer barrel and along the axis of the outer barrel thus allowing light to be transmitted therethrough.

3. The digital camera module as claimed in claim 2, wherein an outer screw thread is formed on an outer periphery of the inner barrel, an inner screw thread is formed on an inner periphery of the outer barrel, and the inner screw thread cooperates with the said outer screw thread.

4. The digital camera module as claimed in claim 2, wherein the inner barrel has a closing board at one end thereof, and an aperture is defined on the closing board along the axis of the inner barrel.

5. The digital camera module as claimed in claim 4, wherein the aperture has a view angle between 30 and 90 degrees.

6. The digital camera module as claimed in claim 4, wherein the aperture has a 60-degree angle of view.

7. The digital camera module as claimed in claim 4, wherein the image sensor is provided in the lens hole and on the image plane of the lens module.

8. The digital camera module as claimed in claim 7, wherein the rotating structure further comprises a lens holder, a receiving hole is defined in one end of the lens holder, and the receiving hole is configured for receiving the lens module.

9. The digital camera module as claimed in claim 8, wherein the lens module is mounted in the receiving hole, and the optical axis of the lens module has an oblique angle according to a rotating axis of the lens holder.

10. The digital camera module as claimed in claim 9, wherein the oblique angle between the optical axis of the lens module and the rotating axis of the lens holder is 30 degrees.

11. The digital camera module as claimed in claim 8, wherein a group of transmission teeth are formed on the inner periphery of the lens holder; the driving member includes a rod and a driving motor connected with the rod, and the rod is configured for interacting with the transmission teeth.

12. The digital camera module as claimed in claim 8, wherein the inner barrel, the outer barrel and the lens holder form a single unit.

13. A digital camera module comprising:
a holder rotatable about a rotation axis;
a lens module mounted to the holder and defining an optical axis, the optical axis being oblique to the rotation axis;
a driving member configured for driving the holder to rotate about the rotating axis while the lens module is imaging.

14. The digital camera module as claimed in claim 13 further comprising an image sensor provided on an image plane of the lens module.

15. The digital camera module as claimed in claim 13, wherein the lens module includes a barrel and at least one lens received in the barrel.

16. The digital camera module as claimed in claim 13, wherein the lens holder defines a receiving hole in one end thereof, and the receiving hole receives the lens module therein.

17. The digital camera module as claimed in claim 13, wherein the oblique angle between the optical axis of the lens module and the rotating axis of the lens holder is 30 degrees.

18. The digital camera module as claimed in claim 16, wherein a group of transmission teeth are formed on the inner periphery of the lens holder; the driving member includes a rod and a driving motor connected with the rod, and the rod is configured for interacting with the transmission teeth.
